(19) United States
(12) Patent Application Publication
(10) Pub. No.: US 2017/0001285 A1
(43) Pub. Date: Jan. 5, 2017

(54) WRENCH WITH SLIDBALE OPERATION MEMBERS FORMING MULITPLE CLAMPING OPTIONS

(71) Applicant: Shu-Min Chen, Taichung (TW)

(72) Inventor: Shu-Min Chen, Taichung (TW)

(21) Appl. No.: 14/790,000

(22) Filed: Jul. 2, 2015

(51) Int. Cl. B25B 13/18

(52) U.S. Cl. CPC B25B 13/18

(57) ABSTRACT

A wrench includes a body having two openings. The body has a chamber in which two operation members are movably located. Each operation member has a first jaw and a second jaw respectively formed on two ends thereof. The first jaws each have a first face protruding out from the first opening. The second jaws each have a second face protruding out from the second opening. Two resilient members are located in the chamber and bias the two operation members to let the two first jaws and the two second jaws are opened wide. The first and second jaws each have slots which are engaged with the lips on each of the openings. The first jaws protruding from the opening form an open wrench, and the second jaws protruding from the other opening form another open wrench.

### BACKGROUND OF THE INVENTION

1. Fields of the invention

The present invention relates to a wrench, and more particularly, to a wrench with slidable operation members to form multiple clamping options.

2. Descriptions of Related Art

The conventional wrench as disclosed in U.S. Pat. No. 8,261,638 which discloses a body with at least six driving portions and each driving portion defines a surface on the body. The surfaces are not overlapped with each other, and the driving portions have different sizes. However, the body is a sphere, six-face body or a multiple-face body which has short diameter and/or length so that the user has to hold the wrench with extra effort to apply a torque to an object. The user usually holds the object by the other hand to be connected with the driving portions so as to operate the wrench, and this causes inconvenience to the users.

The present invention intends to provide a wrench to eliminate the shortcomings mentioned above.

### SUMMARY OF THE INVENTION

The present invention relates to a wrench and comprises a body having a chamber defined therein which includes a first side face and a second side face. The body has a first opening in the first end thereof, and a second opening in the second end of the body. Two first lips are formed on two ends of the first opening, and two second lips are formed on two ends of the second opening. Two operation members are movably located in the chamber and each have a first jaw and a second jaw formed on two ends thereof. The first jaws each have at least one first face, the second jaws each have at least one second face. The at least one first face of each first jaw protrudes out from the first opening, and the at least one second face of each second jaw protrudes out from the second opening. Multiple first slots are defined in a surface of each first jaw and located opposite to the at least one first face. Multiple second slots are defined in a surface of each second jaw and located opposite to the at least one second face. The first lips are engaged with the first slots, and the second lips are engaged with the second slots. Each of the two operation members has an elongate recess and a protrusion. The protrusion of one of the two operation members is movably inserted into the elongate recess of the other operation member. A first open wrench is formed between the two first faces facing each other, and a second open wrench is formed between the two second faces facing each other.

Multiple resilient members are located in the chamber and bias the first and second jaws of the two operation members to be away from each other. The multiple resilient members engage the first lips with the first slots, and the second lips with the second slots.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the wrench of the present invention;

FIG. 2 is a side view of the wrench of the present invention;

FIG. 3 is a side view of the operation member of the wrench of the present invention;

FIG. 4 is a perspective view to show the wrench of the present invention, wherein the cover is removed;

FIG. 5 is a perspective view to show the wrench of the present invention;

FIG. 6 shows the first status of the wrench of the present invention;

FIG. 7 shows the second status of the wrench of the present invention;

FIG. 8 is an exploded view of the second embodiment of the wrench of the present invention;

FIG. 9 is a side view of the wrench in FIG. 8 of the present invention;

FIG. 10 is an exploded view of the third embodiment of the wrench of the present invention;

FIG. 11 is a perspective view of the third embodiment of the wrench of the present invention;

FIG. 12 is an exploded view of the fourth embodiment of the wrench of the present invention, and

FIG. 13 is a perspective view of the fourth embodiment of the wrench of the present invention.

### DETAILED DESCRIPTION OF THE PREFERRED EMBODIMENT

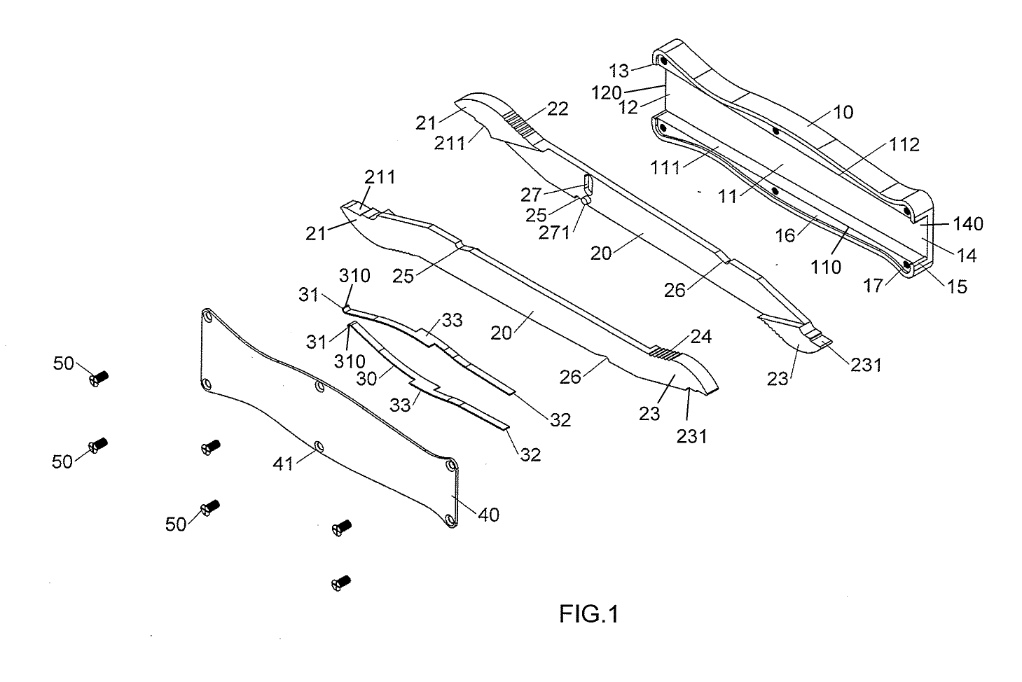

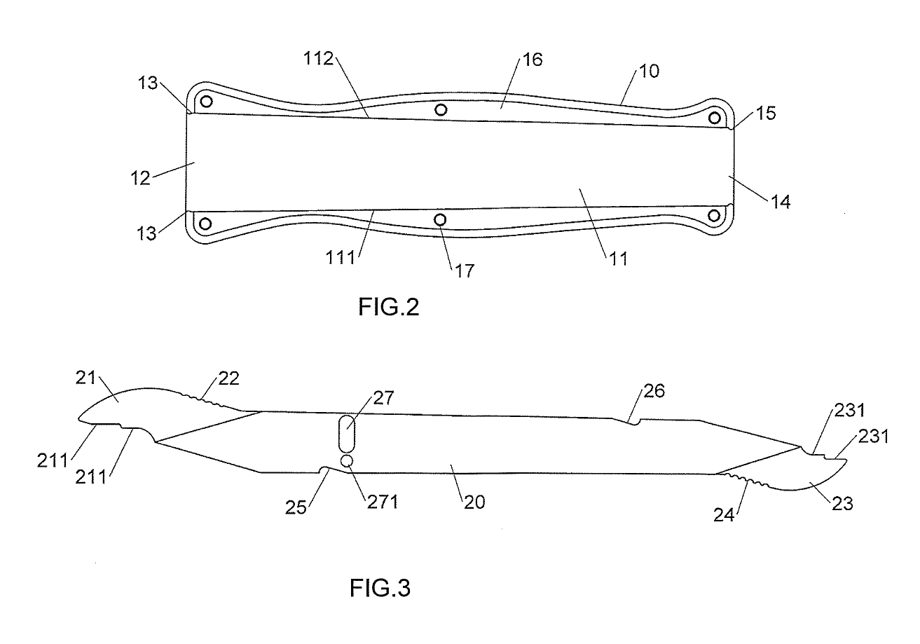

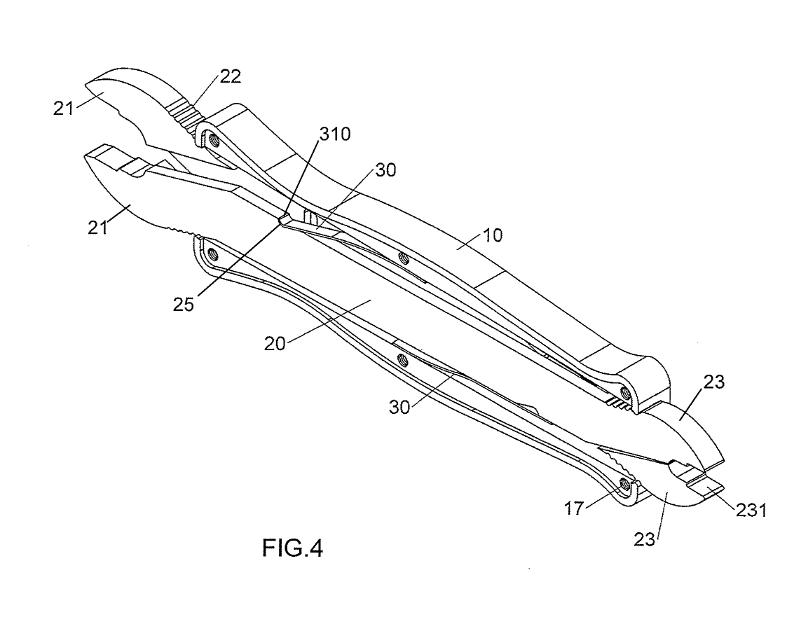

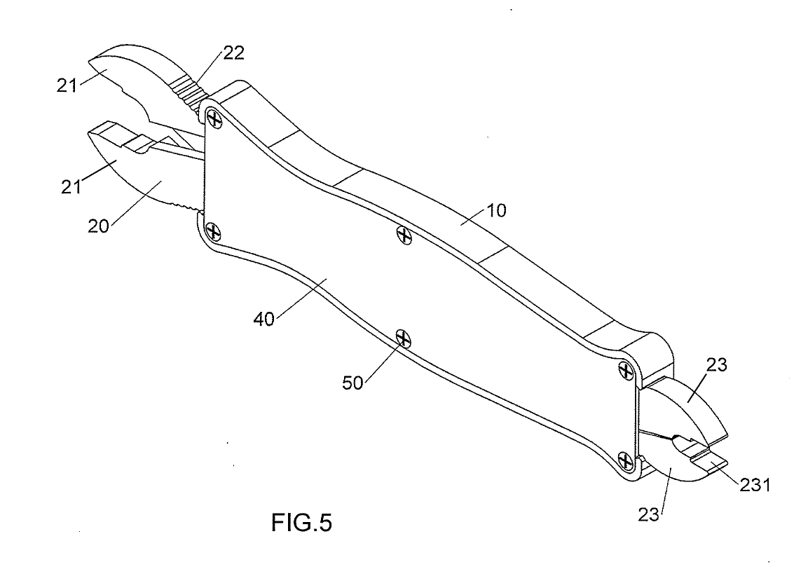

Referring to FIGS. 1 to 5, the wrench of the present invention comprises a body 10, two operation members 20, two resilient members 30, a cover 40 and six bolts 50. The body 10 is an elongate member and has a chamber 11 defined in an inside thereof. A first side face 111 and a second side face 112 are respectively formed on two sides of the chamber 11. The first and second side faces 111, 112 each are a flat face. The body 10 has a first opening 120 defined in the first end 12 thereof, and a second opening 140 defined in the second end 14 of the body 10. Two semi-cylindrical first lips 13 are formed on two ends of the first opening 120, and two semi-cylindrical second lips 15 are formed on two ends of the second opening 140. The first and second lips 13, 15 have the same shape. The width of the second opening 140 is smaller than that of the first opening 120, so as to from the chamber 11 to be a trapezoid chamber. The body 10 has a recessed area 16 defined an end face of each of the first and second side faces 111, 112. Multiple threaded holes 17 are defined in the inner end of each of the recessed area 16. A cover 40 has multiple holes 41 which are located aligned with the threaded holes 17. Multiple bolts 50 extend through the holes 41 and are threadedly connected to the threaded holes 17 so as to connect the cover 40 to the body 10

The two operation members 20 are movably located in the chamber and each have a first jaw 21 and a second jaw 23 respectively formed on two ends thereof. The thickness of each of the first and second jaws 21, 23 is thicker than that of each of the operation members 20. Preferably, the thickness of each of the first and second jaws 21, 23 is two times of the thickness of each of the operation members 20. The first jaws 21 each have a first face 211, and the second jaws 23 each have a second face 231. The first face 211 of each first jaw 21 protrudes out from the first opening 120, and the second face 231 of each second jaw 23 protrudes out from the second opening 140. Multiple first slots 22 are defined transversely in a surface of each first jaw 21 and located opposite to the first face 211. Multiple second slots 24 are defined transversely in a surface of each second jaw 23 and located opposite to the second face 231. The first lips 13 are engaged with the first slots 22, and the second lips 15 are engaged with the second slots 24. The first and second lips 13, 15 have the same shape, and the first and second slots 22, 24 have the same shape. The second jaw 23 is smaller than the first jaw 21 of each of the operation members 20. Each of the two operation members 20 has an elongate recess 27 and a protrusion 271. The protrusion 271 of one of the two operation members 20 is movably inserted into the elongate recess 27 of the other operation member 20. Each of the two operation members 20 has a first notch 25 and a second notch 26, wherein the first notch 25 is located close to the first jaw 21, and the second notch 26 is located close to the second jaw 23. A first open wrench is formed between the two first faces 211 facing each other, and a second open wrench is formed between the two second faces 231 facing each other. The distance between the two first faces 211 is larger than that of the second jaws 23.

The resilient members 30 are located in the chamber 11 and bias the first and second jaws 21, 23 of the two operation members 20 to be away from each other. The resilient members 30 also provide resilient force to engage the first lips 13 with the first slots 22, and the second lips 15 with the second slots 24.

Each resilient member 30 is an elongate and curved metal plate which has a first resilient portion 31, a second resilient portion 32 and a third resilient portion 33 which is located between the first and second resilient portions 31, 32. The first and second resilient portions 31, 32 of each resilient member 30 respectively bias the operation member 20 corresponding thereto. The first resilient portion 31 of each resilient member 30 has a hook 310 extending therefrom, and the hook 310 is engaged with the first notch 25. The second resilient portion 32 is engaged with the other operation member 20. The two respective third resilient portions 33 of the two resilient members 30 respectively contact the first and second side faces 111, 112 of the body 10. The first resilient portion 31 of each resilient member 30 is a curved portion. The second resilient portion 32 of each resilient member 30 is a flat portion. The third resilient portion 33 of each resilient member 30 is a curved portion. The width of the third resilient portion 33 is two times of the width of each of the first and second resilient portions 31, 32.

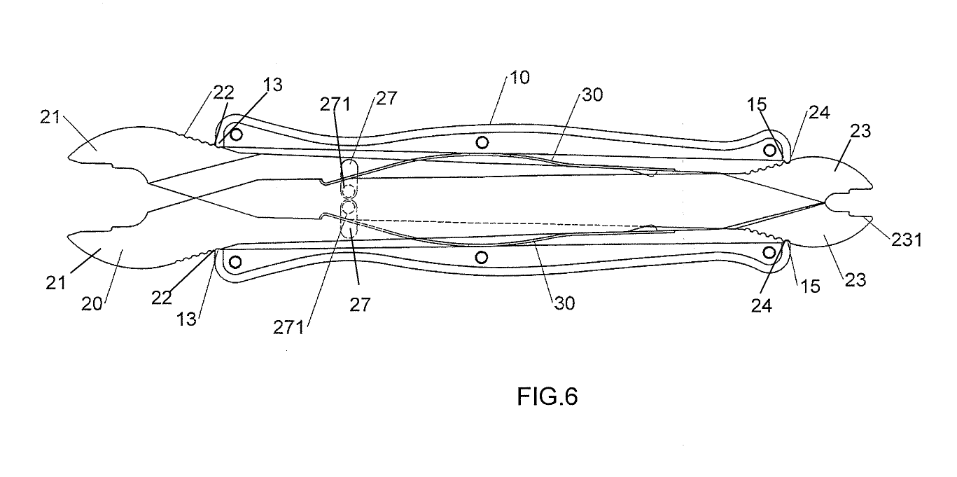

As shown in FIG. 6, the user shifts the two operation members 20 in the chamber 11 to the most left position, the first lips 13 are engaged with the right most first slots 22 of the operation member 20, and the second lips 15 are engaged with the right most second slots 24 of the operation member 20. Therefore, the distance between the two first faces 211 is maximum to clamp a larger object. The distance between the two second faces 231 is minimum to clamp a smaller object. The distance between the two protrusions 271 is minimized.

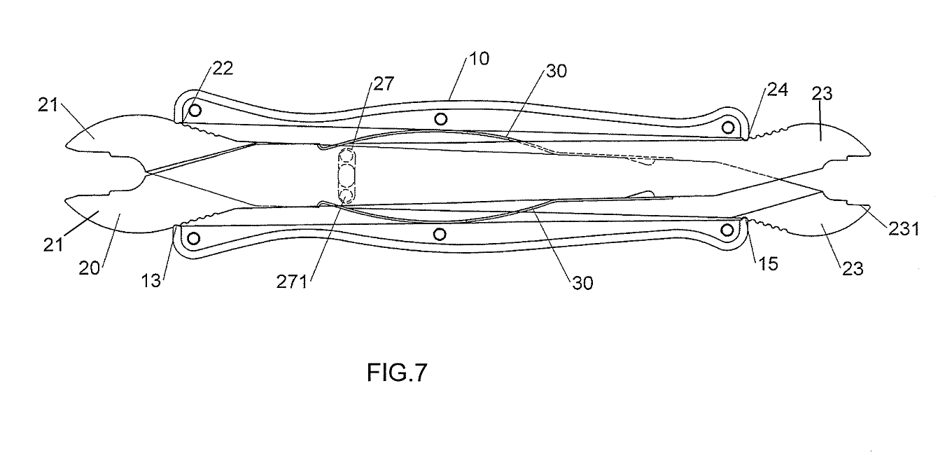

As shown in FIG. 7, the user shifts the two operation members 20 in the chamber 11 to the most right position, the first lips 13 are engaged with the left most first slots 22 of the operation member 20, and the second lips 15 are engaged with the left most second slots 24 of the operation member 20. Therefore, the distance between the two first faces 211 is adjusted. The distance between the two second faces 231 is also adjusted. The distance between the two protrusions 271 is maximized.

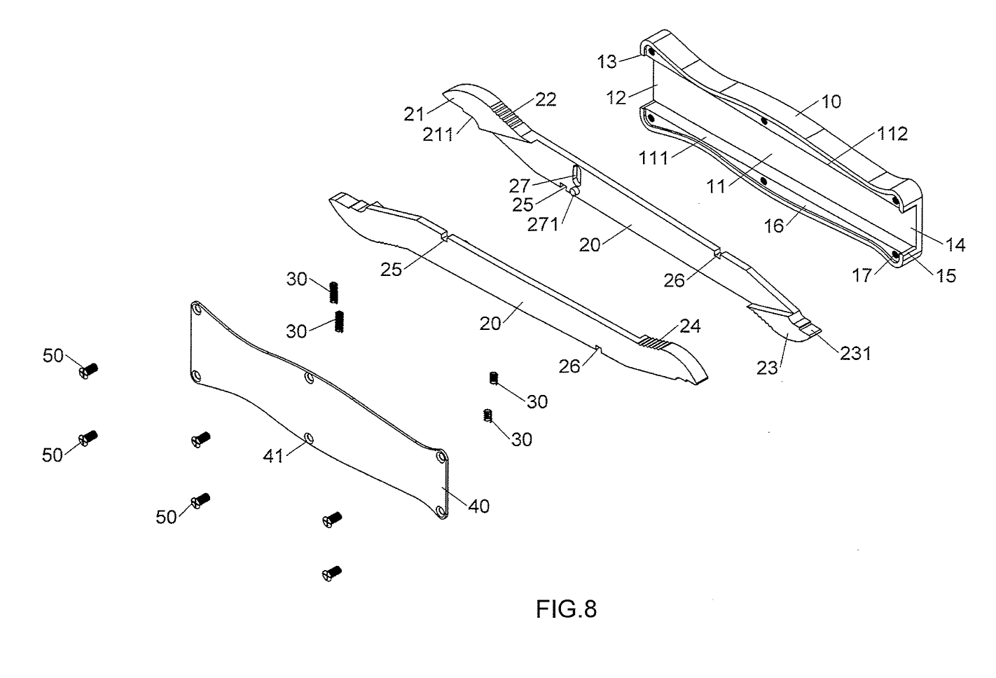

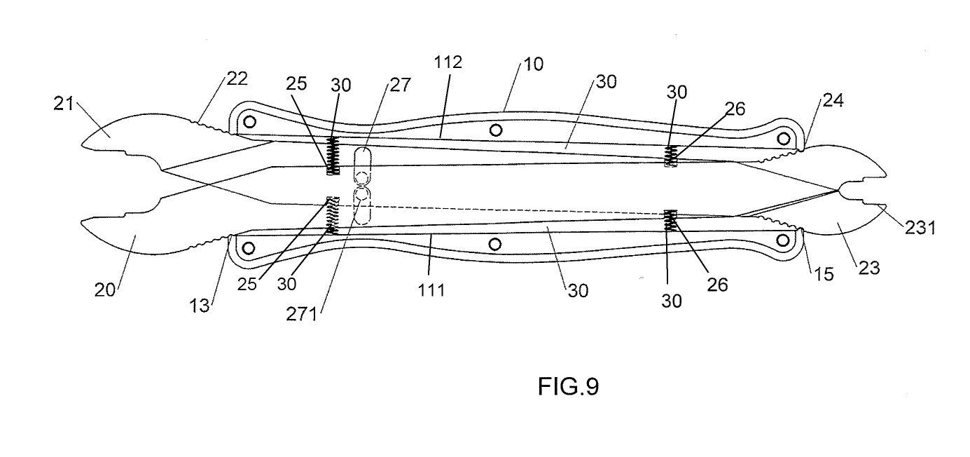

As shown in FIGS. 8 and 9, there are four resilient members 30 which are springs, two of the resilient members 30 bias the notches 25 and the second notches 26 of one side of the operation members 20, and the first side face 111 of the body 10. The other two of the resilient members 30 bias the notches 25 and the second notches 26 of the other side of the operation members 20, and the second side face 112 of the body 10. Therefore, the two ends of the two operation members 20 are respectively opened relative to the two first faces 21 and the two second faces 23.

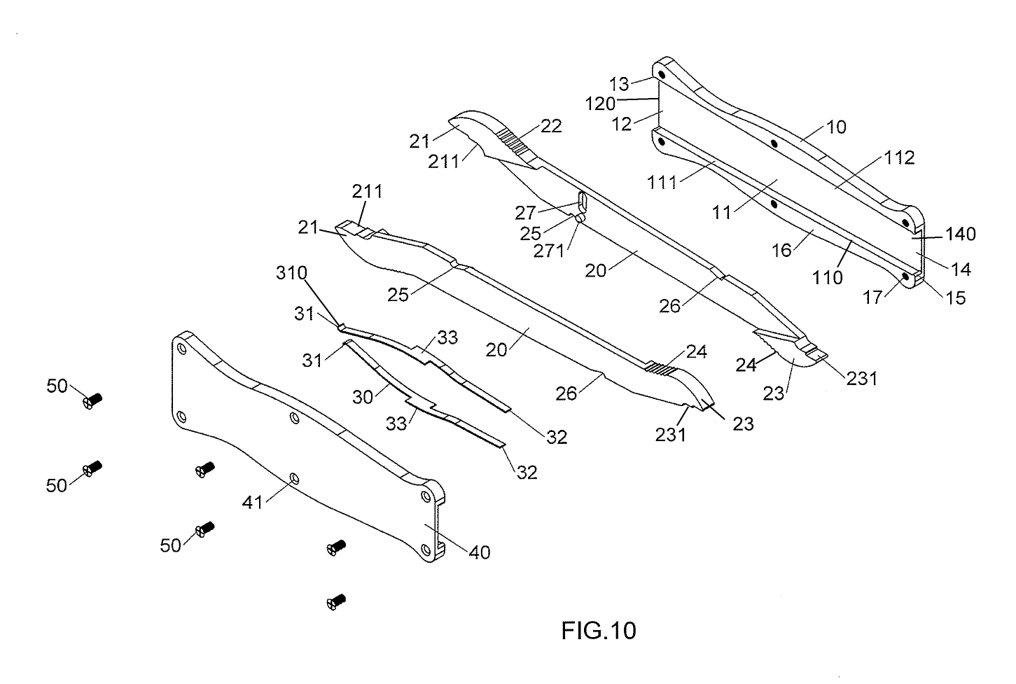

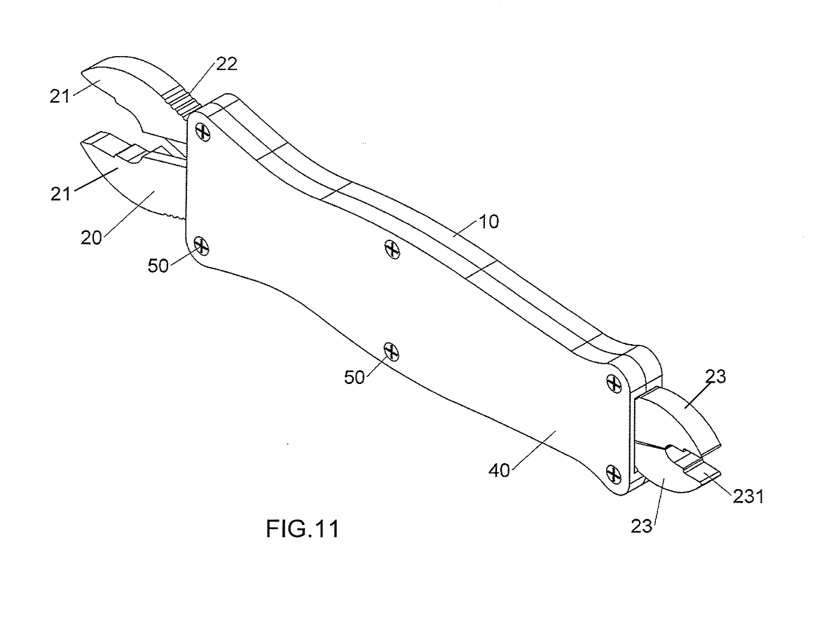

FIGS. 10 and 11 show that the cover 40 is identical to the body 10 and is connected to the body 10. The two operation members 20 are located between the cover 40 and the body 10.

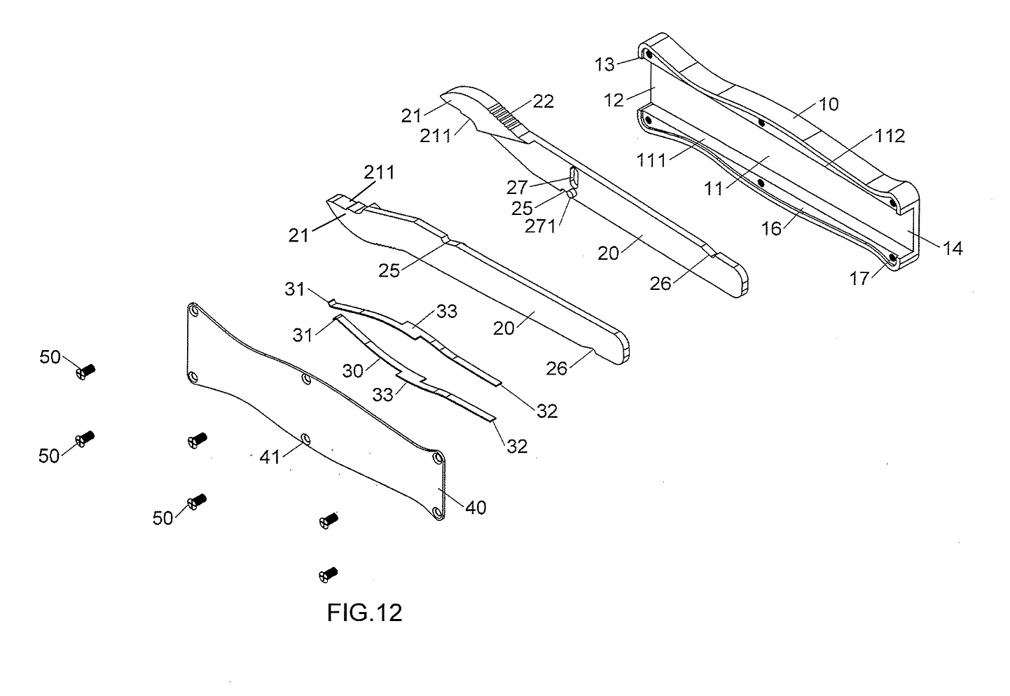

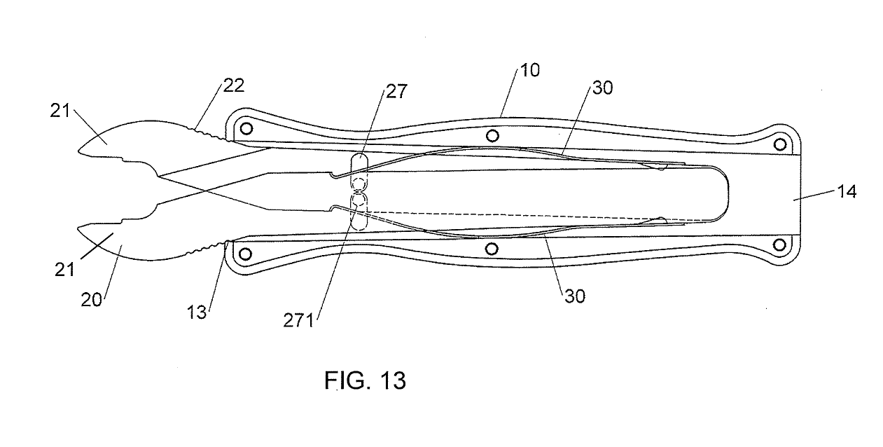

FIGS. 12 and 13 show that the body 10 does not have the second lips 15, and the operation members 20 do not have the second jaws 23, the second faces 231 and the second slots 24. In other words, the wrench has only one driving end. The wrench of the present invention provides multiple sizes of the open wrenches by moving the two operation members 20 so as to drive the objects of different sizes as shown in FIGS. 6 and 7.

As shown in FIGS. 4, 6 and 7, the first, second and third resilient portions 31, 32, 33 of the resilient member 30 respectively contact the operation member 20, the body 10 and the other operation member 20 to engage the first lips 13 and the second lips 15 with the first and second slots 22, 24 respectively to position the two operation members 20. The operation members 10 and the resilient members 30 are operated relative to each other.

The body 10 has a certain length so that the user can easily hold the body to drive the object.

While we have shown and described the embodiment in accordance with the present invention, it should be clear to those skilled in the art that further embodiments may be made without departing from the scope of the present invention.

What is claimed is:

1. A wrench comprising:
a body having a chamber defined in an inside thereof, a first side face and a second side face respectively formed on two sides of the chamber, the body having a first opening defined in a first end thereof, a second opening defined in a second end of the body, two first lips formed on two ends of the first opening, two second lips formed on two ends of the second opening, a width of the second opening being smaller than that of the first opening, the chamber being a trapezoid chamber;
two operation members movably located in the chamber and each having a first jaw and a second jaw respectively formed on two ends thereof, a thickness of each of the first and second jaws being thicker than that of each of the operation members, the first jaws each having at least one first face, the second jaws each having at least one second face, the at least one first face of each first jaw protruding out from the first opening, the at least one second face of each second jaw protruding out from the second opening, multiple first slots defined in a surface of each first jaw and located opposite to the at least one first face, multiple second slots defined in a surface of each second jaw and located opposite to the at least one second face, the first lips engaged with the first slots, the second lips engaged with the second slots, the second jaw being smaller than the first jaw of each of the operation members, each of the two operation members having an elongate recess and a protrusion, the protrusion of one of the two operation members movably inserted into the elongate recess of the other operation member, a first open wrench formed between the two first faces facing each other, a second open wrench formed between the two second faces facing each other, and
multiple resilient members located in the chamber and biasing the first and second jaws of the two operation members to be away from each other, the multiple resilient members engaging the first lips with the first slots, and the second lips with the second slots.

2. The wrench as claimed in claim 1, wherein the first and second side faces each are a flat face.

3. The wrench as claimed in claim 1, wherein the body has a recessed area defined an end face of each of the first and second side faces, multiple threaded holes defined in an inner end of each of the recessed area, a cover has multiple holes which are located aligned with the threaded holes, multiple bolts extend through the holes and are threadedly connected to the threaded holes so as to connect the cover to the body

4. The wrench as claimed in claim 1, wherein there are multiple first faces and second faces.

5. The wrench as claimed in claim 1, wherein the first slots and the second slots are transversely defined in the operation members.

6. The wrench as claimed in claim 1, wherein each of the two operation members has a first notch and a second notch, the first notch is located close to the first jaw, the second notch is located close to the second jaw, there are two resilient members and each resilient member is an elongate and curved plate which has a first resilient portion, a second resilient portion and a third resilient portion which is located between the first and second resilient portions, the first and second resilient portions of each resilient member respectively bias the operation member corresponding thereto, the first resilient portion is engaged with the first notch and the second resilient portion is engaged with the other operation member, the two respective third resilient portions of the two resilient members respectively contact the first and second side faces of the body.

7. The wrench as claimed in claim 6, wherein the first resilient portion of each resilient member has a hook extending therefrom, the hook is engaged with the first notch.

8. The wrench as claimed in claim 6, wherein the first resilient portion of each resilient member is a curved portion, the second resilient portion of each resilient member is a flat portion, the third resilient portion of each resilient member is a curved portion, a width of the third resilient portion is two times of a width of each of the first and second resilient portions.

9. The wrench as claimed in claim 1, wherein there are four resilient members which are springs, two of the resilient members are located between the first side face of the body and one side of the operation members, the other two of the resilient members are located between the second side face of the body and the other side of the operation members.

10. The wrench as claimed in claim 1 further comprising a cover which is identical to the body and is connected to the body, the two operation members located between the cover and the body.

11. The wrench as claimed in claim 1, wherein the first and second lips have the same shape, the first and second slots have the same shape, a thickness of each of the first and second jaws is two times of a thickness of each of the operation members.
